(19) United States
(12) Patent Application Publication
(10) Pub. No.: US 2012/0151532 A1
(43) Pub. Date: Jun. 14, 2012

(54) SDV QUICK TUNE ALGORITHM

(75) Inventors: Christopher S. Del Sordo, Souderton, PA (US); Patrick J. Leary, Horsham, PA (US); John A. Schlack, Quakertown, PA (US); Yeqing Wang, Horsham, PA (US)

(73) Assignee: GENERAL INSTRUMENT CORPORATION, Horsham, PA (US)

(21) Appl. No.: 12/964,379

(22) Filed: Dec. 9, 2010

(51) Int. Cl. H04N 5/445

(52) U.S. Cl. 725/59

(57) ABSTRACT

A switched digital video (SDV) system and method that provides a seamless transition when tuning a set-top box from a first SDV service to a second SDV service. The method detects a set up service trigger in a content stream before a tune request time to transition the content stream from the first SDV service to the second SDV service, and sends a request to set up the second SDV service at a time before the tune request time, where a time difference between the time and the tune request time is greater than a service set up time for the second SDV service. The method detects a tune request in the content stream for the second SDV service, sends a service select request to tune to the second SDV service, and receives the second SDV service at the tune request time.

### BACKGROUND

A digital video broadcast system allows a multiple system operator (MSO) to deliver television programs and multimedia services to subscribers. The capacity, or bandwidth, of the system determines the programs and services that the MSO delivers. In legacy broadcast systems, the MSO sends all of the available programs and services to the subscriber's set-top box on a single cable. Thus, the only way to increase the programs and services available to subscribers in legacy broadcast systems is to increase the bandwidth.

A switched digital video (SDV) system is an improvement to the legacy broadcast systems. The SDV system requires less bandwidth to deliver high-bandwidth digital services by allowing the MSO to send only the content requested by a service group, where each service group includes a set of set-top boxes with visibility to a common set of switched edge quadrature amplitude modulator (QAM) devices. To make this possible, the subscriber's set-top box communicates with a network side video server to request the program that the subscriber wants to watch in real time. The SDV system responds by delivering the requested program to the subscriber's service group. Thus, the service group only receives the programs that subscribers in the service group are watching.

In the SDV system, the switched video manager is responsible for managing which SDV services should reside in an SDV transport stream. During this management process, it may become necessary for the switched video manager to add an SDV service to an edge QAM device as a result of a tune request from a subscriber's set-top box SDV client.

The problem with the tune request is that there is a time delay for the switched video manager to tune from a current SDV service to a requested SDV service when the requested SDV service is not currently being delivered to the set-top box that is requesting the service. The switched video manager will not be able to direct an edge resource manager device to deliver the requested SDV service at the exact time that corresponds to a seamless transition between the current SDV service and the requested SDV service. Since the response time for the edge resource manager device, Internet Group Management Protocol (IGMP) join time, and the time to convert IP to MPEG are not constant, the time delay may vary on the order of hundreds of milliseconds depending on the loading of the various systems. Furthermore, the time required for message communication between the SDV client in the set-top box and switched video manager, and message communication between the switched video manager and the switching equipment may add to this delay.

There is a demand for a method and system for providing a seamless transition when tuning a set-top box from a current SDV service to a requested SDV service for some features that require seamless transitions. The presently disclosed invention satisfies this demand.

### SUMMARY

Aspects of the present invention provide a switched digital video (SDV) system and method that provides a seamless transition when tuning a set-top box from a first SDV service to a second SDV service. The method detects a set up service trigger in a content stream before a tune request time to transition the content stream from the first SDV service to the second SDV service, and sends a request to set up the second SDV service at a time before the tune request time, where a time difference between the time and the tune request time is greater than a service set up time for the second SDV service. The method detects a tune request in the content stream for the second SDV service, sends a service select request to tune to the second SDV service, and receives the second SDV service at the tune request time.

### BRIEF DESCRIPTION OF THE DRAWINGS

FIG. 1 is a network diagram that illustrates one embodiment of the hardware components of a system that performs the present invention.

FIG. 2 is a block diagram that illustrates, in detail, one embodiment of the hardware components shown in FIG. 1.

FIG. 3 is a message flow diagram that illustrates methods according to various embodiments of the present invention.

FIG. 4 is a block diagram that illustrates one embodiment of an acquired content stream processed by the present invention.

### DETAILED DESCRIPTION

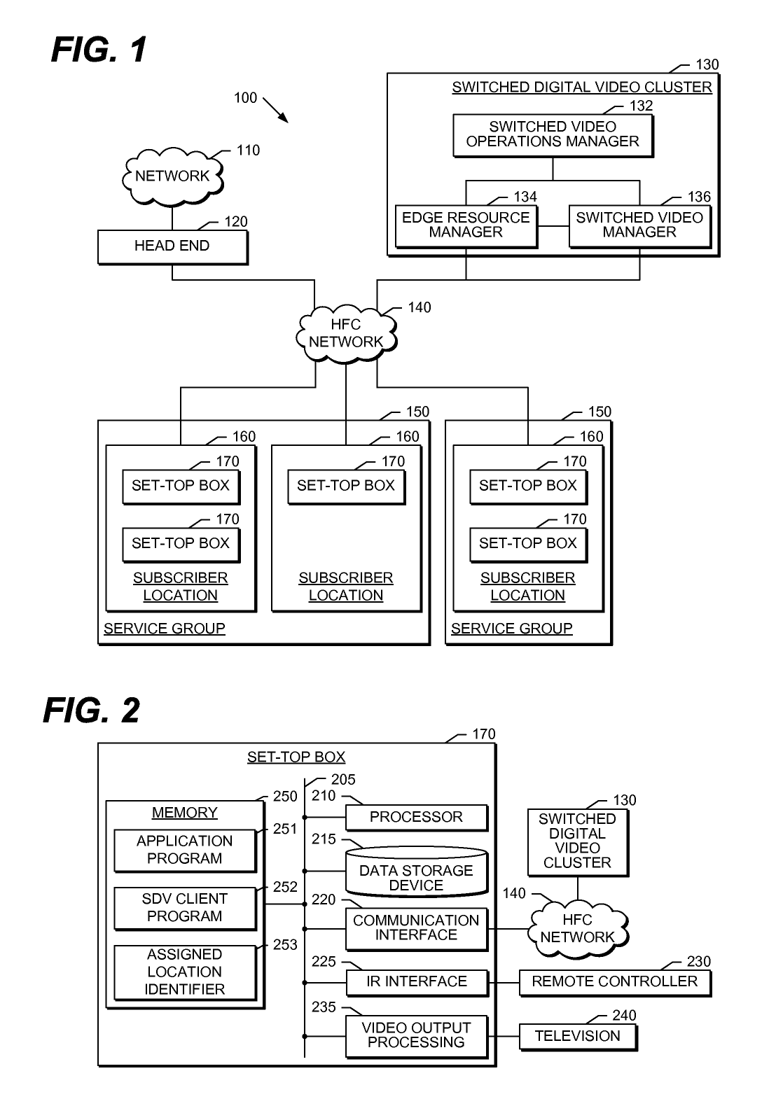

FIG. 1 is a network diagram that illustrates one embodiment of the hardware components of a system that performs the present invention. A switched digital video (SDV) broadcast system 100 includes a network 110 and a hybrid fiber-coaxial (HFC) network 140. The HFC network 140 is a data and video content network that connects a gateway, such as a cable television head end 120, to an SDV cluster 130, and subscriber location 160. The SDV broadcast system 100 shown in FIG. 1 may include any number of interconnected networks 110, head ends 120, SDV clusters 130, HFC networks 140, and subscriber locations 160.

The head end 120, in one embodiment, is a cable television master head end facility for receiving television signals for processing and distribution over a cable television system. The head end 120 provides the subscriber location 160 with a variety of services and/or connections, such as the connection to the network 110. For example, the head end 120 may provide a connection to external services such as video servers, public switched telephone network voice, multimedia messages, and internet data.

The switched video operations manager (SVOM) 132, edge resource manager (ERM) 134, and switched video manager (SVM) 136 are the components comprising the SDV cluster 130 for the SDV broadcast system 100. The SVOM 132 is a computing device, including a processor and memory, which configures, monitors, and collects data from the ERM 134 and SVM 136 components. A cable operator uses the SVOM 132 to configure channels for SDV services, manage service group mappings, and administer the ERM 134, SVM 136, and edge QAM device (not shown) relationships. The ERM 134 is a computing device, including a processor and memory, which manages the edge QAM device relationships in the head end 120 as established by the cable operator's policies. The ERM 134 receives requests for edge QAM devices, and selects the appropriate edge QAM device to satisfy the bandwidth requirements of the request. The SVM 136 is a computing device, including a processor and memory, which manages the SDV streams that are active at any given time, and directs each stream to the appropriate set-top box 170 that requested the stream. The SVM 136 also tracks the channels viewed by each set-top box 170, and communicates with the ERM 134 to establish the requested channels.

The SDV cluster 130 provides the SDV broadcast system 100 with features that are greatly affected by a time delay during a tuning transition and benefit from a seamless or “on the spot” tuning transition. These features include, but are not limited to, the insertion of targeted advertisements into a content stream, and the splicing of a Moving Picture Experts Group (MPEG) elementary stream when switching between audio and video (AN) service components.

In one embodiment, the SDV cluster 130 coordinates the insertion of targeted advertisements into a show that a subscriber is watching. The show includes a primary advertisement that is replaced by the targeted advertisement. To accomplish this replacement, when the video stream for the show encounters the beginning of the primary advertisement, the SDV cluster 130 tunes to another service so that the subscriber can view the targeted advertisement. When the video stream encounters the end of the targeted advertisement, the SDV cluster 130 tunes back to the video stream for the show. During these tuning transitions, the subscriber will be annoyed if there is a time delay between the show and the targeted advertisement spot, or between the targeted advertisement spot and the show. In addition, since these targeted advertisements generate a significant revenue stream, the time delay is lost advertisement time that negatively impacts the revenue stream.

In another embodiment, the SDV cluster 130 coordinates the splicing of an MPEG elementary stream when switching between A/V service components. Since the introduction of the Society of Cable Telecommunications Engineers (SCTE) Digital Video Service Multiplex and Transport System Standard for Cable Television (SCTE 54), services can only include one video component. Thus, the SDV cluster 130 will splice between one set of A/V service components (e.g., service A) to another set of A/V service components (e.g., Service B).

The subscriber location 160 includes a computing device, such as a set-top box 170, to receive, decode and display data and video content, and provide access to the services and/or connections that the head end 120 provides. A service group 150 is an organization that includes a number of subscriber locations 160, each subscriber location 160 including one or more set-top boxes 170. A unique identifier associated with each service group 150, subscriber location 160, and/or set-top box 170 supports the functionality and advantages provided by the head end 120, and SDV cluster 130.

In the SDV broadcast system 100 shown in FIG. 1, the SDV cluster 130 manages a set of edge QAM devices (not shown) that the SDV broadcast system 100 bind and unbind to particular services based on requests from the set-top boxes 170 at the subscriber locations 160. When a viewer decides to change the channel (i.e., tune to another channel), the set-top box 170 sends a channel change message to the SVM 136. The SVM 136 parses the channel change message to obtain an identifier of the service group 150, subscriber location 160, and/or set-top box 170 that identifies the set of switched edge QAM devices visible to the set-top box 170. Typically, a set-top box 170 assigns the identifier via an in-band carousel, or a message exchange with the SVM 136 known as auto-discovery. In the SDV broadcast system 100, the SDV cluster 130 uses the identifier to bind the requested channel to an edge QAM device visible to the service group 150.

The network 110 shown in FIG. 1, in one embodiment, is a public communication network or wide area network (WAN). The present invention also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA), Code Division Multiple Access (CDMA), or Orthogonal Frequency Division Multiplexing (OFDM) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Internet Protocol, and Transmission Control Protocol. In various embodiments, the network 110 will support a variety of network interfaces, including 802.3ab/u/etc., Multimedia over Coax Alliance (MoCA), and 801.11.

The HFC network 140 shown in FIG. 1, in one embodiment, is a broadband network that combines optical fiber and coaxial cable, technology commonly employed globally by cable television operators since the early 1990s. The fiber optic network extends from the cable operators master head end, sometimes to regional head ends, and out to a neighborhood hubsite, and finally to a fiber optic node that serves anywhere from 25 to 2000 homes. The master head end will usually have satellite dishes for reception of distant video signals as well as IP aggregation routers. Some master head ends also house telephony equipment for providing telecommunications services to the community. The regional head ends receive the video signal from the master head end and add to it the Public, Educational and/or Governmental (PEG) channels as required by local franchising authorities or insert targeted advertising that would appeal to the region. The various services are encoded, modulated and up-converted onto RF carriers, combined onto a single electrical signal and inserted into a broadband optical transmitter. This optical transmitter converts the electrical signal to a downstream optically modulated signal that is sent to the nodes. Fiber optic cables connect the head end to optical nodes in a point-to-point or star topology, or in some cases, in a protected ring topology.

FIG. 2 is a block diagram that illustrates, in detail, one embodiment of the hardware components shown in FIG. 1. In particular, FIG. 2 illustrates the hardware components and software comprising the set-top box 170 shown in FIG. 1.

The set-top box 170, in one embodiment, is a general-purpose computing device that performs the present invention. A bus 205 is a communication medium that connects a processor 210, data storage device 215 (such as a Serial ATA (SATA) hard disk drive, optical drive, Small Computer System Interface (SCSI) disk, flash memory, or the like), communication interface 220, infrared (IR) interface 225, video output processing 235, and memory 250 (such as Random Access Memory (RAM), Dynamic RAM (DRAM), non-volatile computer memory, flash memory, or the like). The communication interface 220 connects the set-top box 170 to the HFC network 140. The IR interface 225 connects the set-top box 170 to a remote controller 230. The video output processing 235 connects the set-top box 170 to a display device such as a television 240, and sends the video content that the television 240 screen displays. In one embodiment, the implementation of the present invention on the set-top box 170 is an application-specific integrated circuit (ASIC).

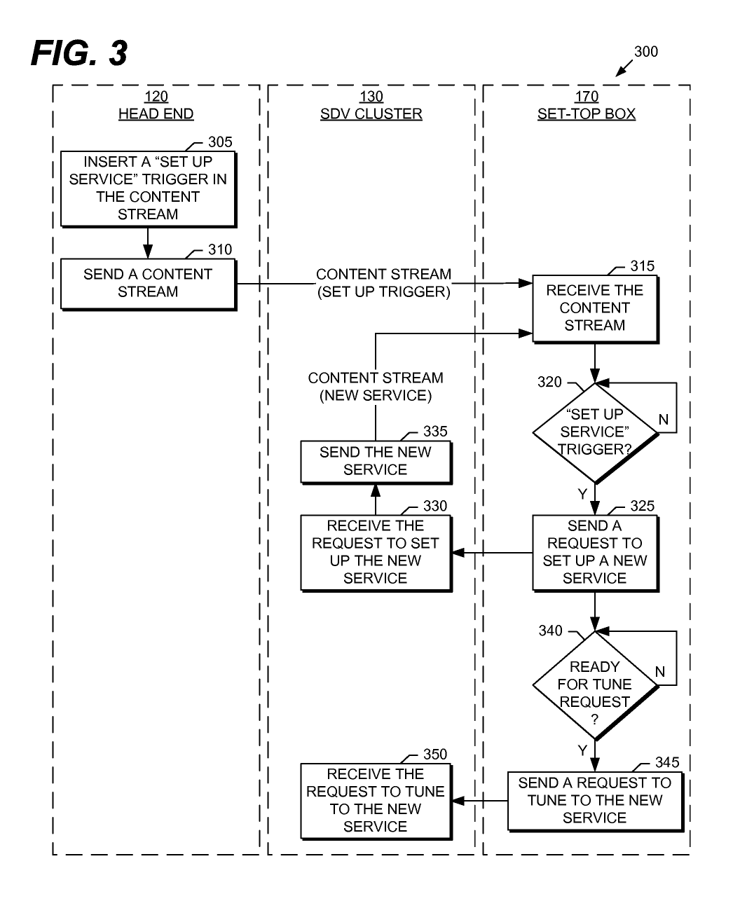

The processor 210 performs the disclosed methods by executing the sequences of operational instructions that comprise each computer program resident in, or operative on, the memory 250. The reader should understand that the memory 250 may include operating system, administrative, and database programs that support the programs disclosed in this application. In one embodiment, the configuration of the memory 250 of the set-top box 170 includes an application program 251, SDV client program 252, and assigned location identifier 253. The application program 251 provides the viewer with access to basic functions, such as the display of a video content stream on the television 240, and advanced functions, such as video-on-demand (VOD), interactive television, and other next-generation television application programs. The SDV client program 252 is a program that interfaces with the SDV cluster 130 to provide the SDV broadcast system 100 with features that are greatly affected by a time delay during a tuning transition and benefit from a seamless or “on the spot” tuning transition. The assigned location identifier 253 is an identifier that associates the set-top box 170 to a location, such as a service group 150 or subscriber location 160. The application program 251, SDV client program 252, and assigned location identifier 253 perform the methods of the present invention disclosed in detail in FIG. 3. When the processor 210 performs the disclosed methods, it stores intermediate results in the memory 250 or data storage device 215. In another embodiment, the memory 250 may swap these programs, or portions thereof, in and out of the memory 230 as needed, and thus may include fewer than all of these programs at any one time.

FIG. 3 is a flow diagram that illustrates a method according to one embodiment of the present invention. In particular, FIG. 3 illustrates the communication between the head end 120, SDV cluster 130, and set-top box 170.

The process 300 shown in FIG. 3, with reference to FIG. 1 and FIG. 2, begins when the head end 120 inserts a “set up service” trigger into a content stream (step 305). The “set up service” trigger identifies the service for an upcoming tuning transition in the content stream at the tuning transition time specific to the feature that requires a seamless transition. The head end 120 inserts the “set up service” trigger in the content stream before the tuning transition time, and sufficiently early enough, to ensure that the SDV cluster 130 is able to set up the SDV service for the set-top box 170 before the seamless tuning transition takes place. In one embodiment, the head end 120 inserts the “set up service” trigger in the user data portion of an MPEG elementary picture data stream. The MPEG user data feature provides a means to inject application-specific data into an MPEG elementary stream. User data can be inserted on three different levels, the sequence level, the group of pictures (GOP) level, and the picture data level. An application that processes MPEG data do not need to be able to understand data encapsulated in this way, but should be able to preserve it. Other examples of information embedded in MPEG streams as user data are aspect ratio information, “hidden” information per the Active Format Descriptor specification, and closed captioning per the Electronics Industries Association (EIA) Closed Captioning standard (i.e., EIA-708).

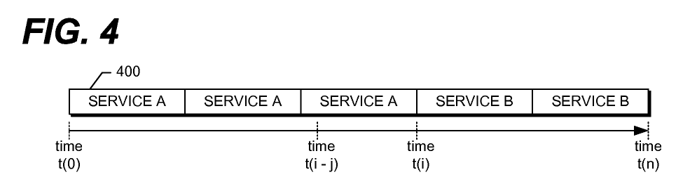

FIG. 4 is a block diagram that illustrates one embodiment of an acquired content stream processed by the present invention. As shown in FIG. 4, the content stream 400 is a sequential picture data stream that includes sequential content associated with service A and sequential content associated with service B. The content stream 400 includes the sequential content associated with service A from time t(0) to time t(i). The content stream 400 includes the sequential content associated with service B from time t(i) to time t(n). Time t(i) is the tuning transition time (i.e., the tune request time) when the content stream 400 transitions from service A to service B. Time t(i-j) is the time that the head end 120 inserts the “set up service” trigger in the content stream 400. The head end 120 inserts the “set up service” trigger at time t(i-j) because j is a duration of time that is greater than the time needed for the SDV cluster to set up service B, and is sufficiently early enough to allow the set-top box 180 to send a request to set up service B, thereby allowing for a seamless transition from service A to service B.

Referring again to FIG. 3, the process 300 continues by sending the content stream that includes the “set up service” trigger to the set-top box 170 (step 310). In one embodiment, the “set up service” trigger could is inserted via the content server or a feature specific server communicating to the content server. The set-top box 170 receives the content stream that includes the “set up service” trigger (step 315), and begins monitoring the content stream to discover a “set up service” trigger (step 320). Until the set-top box 170 detects a “set up service” trigger, it continues to search the content stream (step 320, N branch). When the set-top box 170 detects a “set up service” trigger (step 320, Y branch), the set-top box 170 retrieves tuning information for a new service that the “set up service” trigger identifies. In one embodiment, the tuning information includes SDV tuning triplet service information which includes an MPEG service number, frequency, and modulation mode, or other special information for the new service that will instruct the set-top box 170 where to tune in advance of the upcoming tuning transition. The set-top box 170 uses the tuning information to send a request to the SDV cluster 130 to set up the new service (step 325), and waits for a tune request (step 340). The SDV cluster 130 receives the request to set up the new service (step 330), and sends the new service associated with the feature (e.g., targeted advertisement, or MPEG splicing) (step 335). Until the set-top box 170 detects a tune request, it continues to search the content stream (step 340, N branch). When the set-top box 170 is ready for the tune request (step 340, Y branch), the set-top box 170 sends a request to the SDV cluster 130 to tune to the new service (step 345). When the SDV cluster 130 receives the request to tune to the new service (step 350), the set-top box 170 receives the content stream that includes the new service (step 315).

Since the new service was set up before the tuning request time, the set-top box 170 receives the new service at the tuning request time, thereby providing a seamless transition when tuning the set-top box 170 from the current SDV service to the new SDV service. In order to carry out the splicing feature in a seamless fashion, the present invention provides a deterministic mechanism to ensure that the SDV cluster 130 is prepared to send a new SDV service to the set-top box 170 prior to the set-top box 170 requesting to tune to the new service. This deterministic mechanism solves the problem of setting up the SDV service prior to the tuning transition point.

Although the disclosed embodiments describe a fully functioning method and system for providing a seamless transition when tuning a set-top box from a current SDV service to a requested SDV service, the reader should understand that other equivalent embodiments exist. Since numerous modifications and variations will occur to those reviewing this disclosure, the method and system for providing a seamless transition when tuning a set-top box from a current SDV service to a requested SDV service is not limited to the exact construction and operation illustrated and disclosed. Accordingly, this disclosure intends all suitable modifications and equivalents to fall within the scope of the claims.

We claim:

1. A method, comprising:
receiving a content stream in a switched digital video (SDV) system, the content stream including sequential content associated with a first SDV service and sequential content associated with a second SDV service, wherein a tune request at a tune request time initiates a transition of the content stream from the first SDV service to the second SDV service;
detecting a set up service trigger in the content stream before the tune request time, the set up service trigger including information associated with the tune request;
sending a request to set up the second SDV service at a time that is before the tune request time, wherein a time difference between the time and the tune request time is greater than a service set up time for the second SDV service;
detecting a tune request in the content stream for the second SDV service;
sending a service select request to tune to the second SDV service; and
receiving the second SDV service at the tune request time.

2. The method of claim 1, wherein the first SDV service is a video entertainment program, and the second SDV service is a targeted advertisement.

3. The method of claim 1, wherein the transition splices a Moving Picture Experts Group (MPEG) elementary stream, and wherein the first SDV service is a first audio/video service, and the second SDV service is a second audio/video service.

4. The method of claim 1, wherein the detecting of the set up service trigger further comprises:
examining a user data portion of the content stream;
locating the set up service trigger in the user data portion; and
storing the information associated with the tune request.

5. The method of claim 1, wherein the information associated with the tune request includes SDV tuning triplet service information which includes an MPEG service number, a frequency, and a modulation mode.

6. The method of claim 1, wherein the transition of the content stream from the first SDV service to the second SDV service is a seamless transition without a time delay.

7. A system, comprising:
a memory device resident in a computing device; and
a processor disposed in communication with the memory device, the processor configured to:
receive a content stream in a switched digital video (SDV) system, the content stream including sequential content associated with a first SDV service and sequential content associated with a second SDV service, wherein a tune request at a tune request time initiates a transition of the content stream from the first SDV service to the second SDV service;
detect a set up service trigger in the content stream before the tune request time, the set up service trigger including information associated with the tune request;
send a request to set up the second SDV service at a time that is before the tune request time, wherein a time difference between the time and the tune request time is greater than a service set up time for the second SDV service;
detect a tune request in the content stream for the second SDV service;
send a service select request to tune to the second SDV service; and
receive the second SDV service at the tune request time.

8. The system of claim 7, wherein the first SDV service is a video entertainment program, and the second SDV service is a targeted advertisement.

9. The system of claim 7, wherein the transition splices a Moving Picture Experts Group (MPEG) elementary stream, and wherein the first SDV service is a first audio/video service, and the second SDV service is a second audio/video service.

10. The system of claim 7, wherein to detect the set up service trigger, the processor is further configured to:
examine a user data portion of the content stream;
locate the set up service trigger in the user data portion; and
store the information associated with the tune request.

11. The system of claim 7, wherein the information associated with the tune request includes SDV tuning triplet service information which includes an MPEG service number, a frequency, and a modulation mode.

12. The system of claim 7, wherein the transition of the content stream from the first SDV service to the second SDV service is a seamless transition without a time delay.

13. A non-transitory computer-readable medium, comprising computer-executable instructions that, when executed on a computing device, perform steps of:
receiving a content stream in a switched digital video (SDV) system, the content stream including sequential content associated with a first SDV service and sequential content associated with a second SDV service, wherein a tune request at a tune request time initiates a transition of the content stream from the first SDV service to the second SDV service;
detecting a set up service trigger in the content stream before the tune request time, the set up service trigger including information associated with the tune request;
sending a request to set up the second SDV service at a time that is before the tune request time, wherein a time difference between the time and the tune request time is greater than a service set up time for the second SDV service;
detecting a tune request in the content stream for the second SDV service;
sending a service select request to tune to the second SDV service; and
receiving the second SDV service at the tune request time.

14. A method, comprising:
sending a content stream in a switched digital video (SDV) system, the content stream including sequential content associated with a first SDV service and sequential content associated with a second SDV service, wherein a tune request at a tune request time initiates a transition of the content stream from the first SDV service to the second SDV service;
inserting a set up service trigger in the content stream before the tune request time, the set up service trigger including information associated with the tune request;
receiving a request to set up the second SDV service at a time that is before the tune request time, wherein a time difference between the time and the tune request time is greater than a service set up time for the second SDV service;
receiving a service select request to tune to the second SDV service; and
sending the second SDV service at the tune request time.

15. The method of claim 14, wherein the first SDV service is a video entertainment program, and the second SDV service is a targeted advertisement.

16. The method of claim 14, wherein the transition splices a Moving Picture Experts Group (MPEG) elementary stream, and wherein the first SDV service is a first audio/video service, and the second SDV service is a second audio/video service.

17. The method of claim 14, wherein the inserting of the set up service trigger further comprises:
locating a user data portion of the content stream; and
storing the information associated with the tune request in the user data portion of the content stream.

18. The method of claim 14, wherein the information associated with the tune request includes SDV tuning triplet service information which includes an MPEG service number, a frequency, and a modulation mode.

19. The method of claim 14, wherein the transition of the content stream from the first SDV service to the second SDV service is a seamless transition without a time delay.

20. A system, comprising:
a memory device resident in a computing device; and
a processor disposed in communication with the memory device, the processor configured to:
send a content stream in a switched digital video (SDV) system, the content stream including sequential content associated with a first SDV service and sequential content associated with a second SDV service, wherein a tune request at a tune request time initiates a transition of the content stream from the first SDV service to the second SDV service;
insert a set up service trigger in the content stream before the tune request time, the set up service trigger including information associated with the tune request;
receive a request to set up the second SDV service at a time that is before the tune request time, wherein a time difference between the time and the tune request time is greater than a service set up time for the second SDV service;
receive a service select request to tune to the second SDV service; and
send the second SDV service at the tune request time.

21. The system of claim 20, wherein the first SDV service is a video entertainment program, and the second SDV service is a targeted advertisement.

22. The system of claim 20, wherein the transition splices a Moving Picture Experts Group (MPEG) elementary stream, and wherein the first SDV service is a first audio/video service, and the second SDV service is a second audio/video service.

23. The system of claim 20, wherein to insert the set up service trigger, the processor is further configured to:
locate a user data portion of the content stream; and
store the information associated with the tune request in the user data portion of the content stream.

24. The system of claim 20, wherein the information associated with the tune request includes SDV tuning triplet service information which includes an MPEG service number, a frequency, and a modulation mode.

25. The system of claim 20, wherein the transition of the content stream from the first SDV service to the second SDV service is a seamless transition without a time delay.

26. A non-transitory computer-readable medium, comprising computer-executable instructions that, when executed on a computing device, perform steps of:
sending a content stream in a switched digital video (SDV) system, the content stream including sequential content associated with a first SDV service and sequential content associated with a second SDV service, wherein a tune request at a tune request time initiates a transition of the content stream from the first SDV service to the second SDV service;
inserting a set up service trigger in the content stream before the tune request time, the set up service trigger including information associated with the tune request;
receiving a request to set up the second SDV service at a time that is before the tune request time, wherein a time difference between the time and the tune request time is greater than a service set up time for the second SDV service;
receiving a service select request to tune to the second SDV service; and
sending the second SDV service at the tune request time.
